(19) United States
(12) Patent Application Publication
(10) Pub. No.: US 2012/0042911 A1
(43) Pub. Date: Feb. 23, 2012

(54) CLEANING DEVICE AND CLEANING METHOD USING SAME

(75) Inventor: MING-YU DENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/110,883

(22) Filed: May 18, 2011

(30) Foreign Application Priority Data
Aug. 18, 2010 (CN) 201010256593.X

(51) Int. Cl. B08B 3/00

(52) U.S. Cl. 134/33; 134/157

(57) ABSTRACT

A cleaning device includes a rotary platform and a cleaning assembly. The rotary platform is used for rotating a workpiece. The cleaning assembly faces the rotary platform and is used for spraying cleaning fluid on the workpiece for a period of time to clean the workpiece and then spraying drying gas on the workpiece to dry the workpiece during the rotary platform rotates the workpiece.

### BACKGROUND

1. Technical Field

The present disclosure relates to a cleaning device and a cleaning method using same.

2. Description of Related Art

An assembly of a sensor and a printed circuit board (PCB) needs to be cleaned before it is packaged with a lens module. Generally, a cleaning pipe is used to spray cleaning fluid on the assembly. Then the assembly is placed in a drying machine to be dried. However, a little of the cleaning fluid can remain on the sensor or the PCB of the assembly and will form blemishes during the drying process, which will affect the image quality of the sensor.

Therefore, it is desirable to provide a cleaning device and a cleaning method using same that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a cleaning device, according to an exemplary embodiment, showing the cleaning device in a first state.

FIG. 2 is similar to FIG. 1, but showing the cleaning device in a second state.

FIG. 3 is similar to FIG. 1, but showing the cleaning device without a in a third state.

FIG. 4 is similar to FIG. 1, but showing the cleaning device in a third state and a protective mask of the cleaning device being removed.

FIG. 5 is a flow chart of a cleaning method using the cleaning device of FIG. 1, according to an exemplary embodiment.

### DETAILED DESCRIPTION

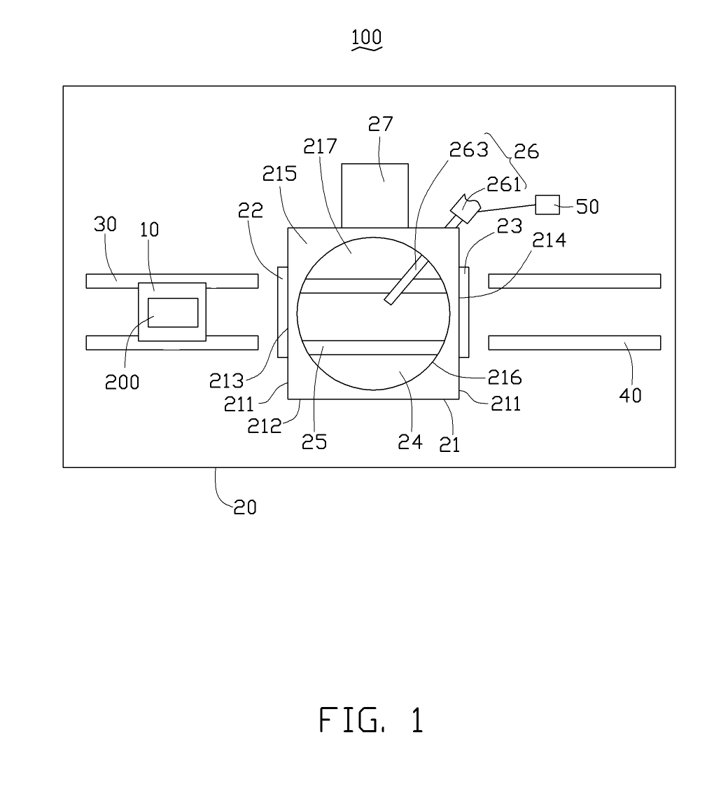

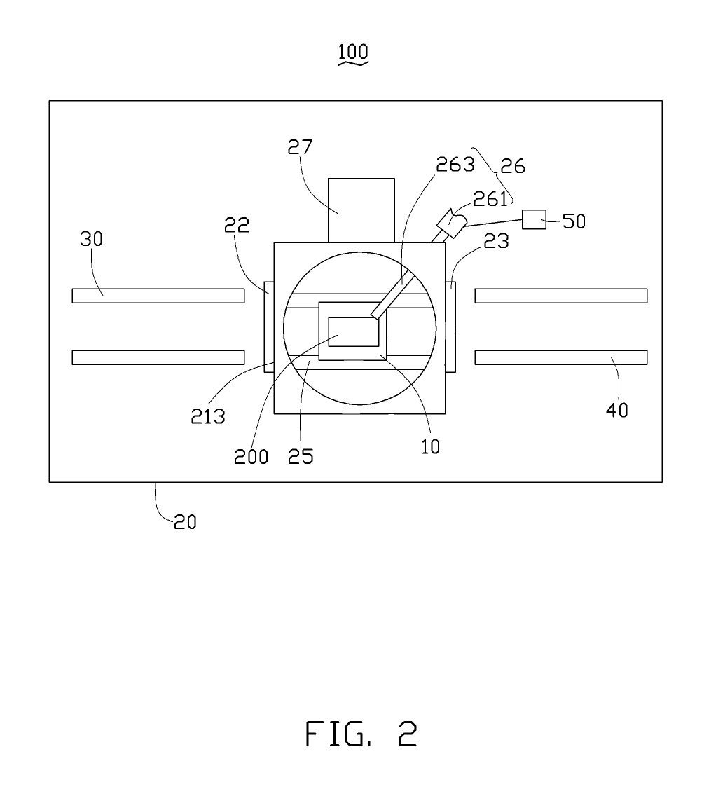

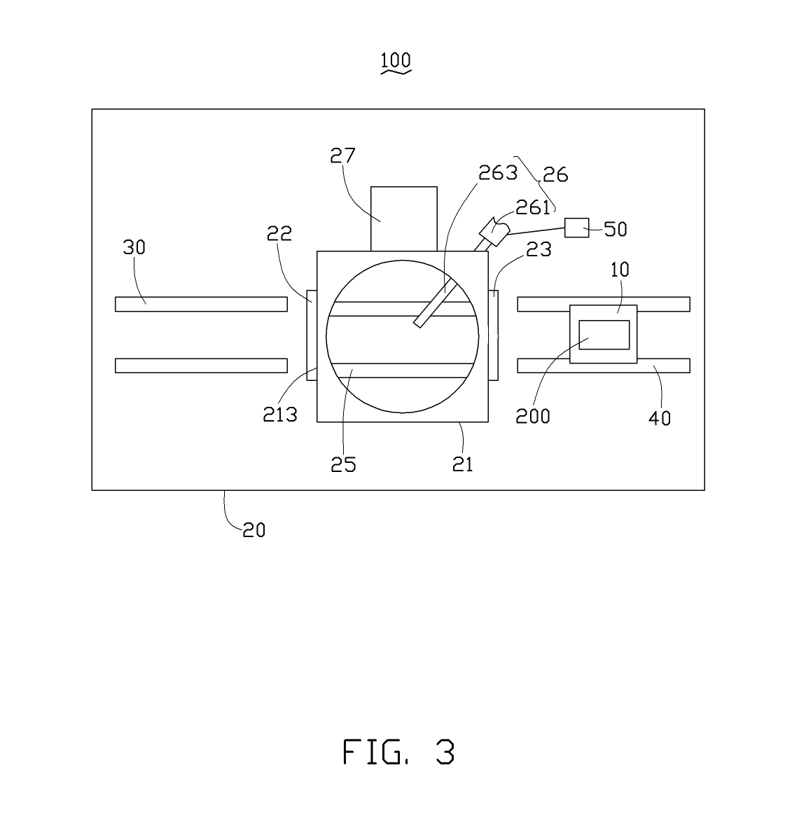

Referring to FIGS. 1-3, a cleaning device 100 is used for cleaning a workpiece 200. In this embodiment, the workpiece 200 is an assembly of a sensor fixed on a PCB.

The cleaning device 100 includes a rectangular loading plate 10, a base 20, a protective mask 21, a first rectangular gate 22, a second rectangular gate 23, a circular rotary platform 24, a middle conveyer 25, a cleaning assembly 26, a blowdown apparatus 27, a first conveyer 30, a second conveyer 40, and a controller 50. The loading plate 10 is used for fixing the workpiece 200 in the center and can slide between the first conveyer 30, the middle conveyer 25, to the second conveyer 40 in turn.

The protective mask 21 is substantially hollow cuboid in shape, and covers on the base 20 to form a working space cooperatively with the base 20. The protective mask 21 includes two parallel first inner sidewalls 211 and a second inner sidewall 212 connecting the two first inner sidewalls 211. One first inner sidewall 211 defines a first through hole 213, the other first inner sidewall 211 defines a second through hole 214 corresponding to the first through hole 213. The first gate 22 movably and hermetically seals the first through hole 213, and the second gate 23 movably and hermetically seals the second through hole 214. The protective mask 21 also includes a top wall 215 perpendicularly connecting the two first inner sidewalls 211 and the second inner sidewall 212. The top wall 215 defines a circular opening 216 coaxial with the center of the rotary platform 24. A circular cover 217 made of transparent material seals the opening 216.

The rotary platform 24 is rotatably disposed on the base 20 and is received in the working space.

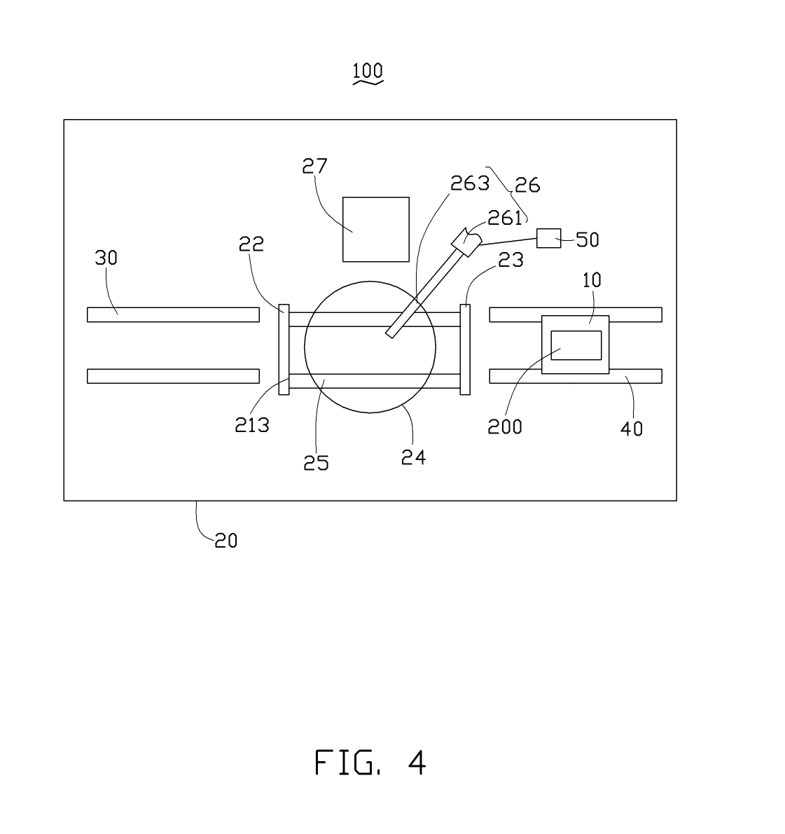

Also referring to FIG. 4, the middle conveyer 25 is fixed on the rotary platform 24 and extends from the first through hole 213 to the second through hole 214. Two mechanic arms (not shown) are disposed on a bottom surface of the loading plate 10 opposite to the workpiece 200. When the rotary platform 24 starts to rotate, the two mechanical arms firmly grasp the middle conveyer 25, and thus the loading plate 10 can rotate with the rotary platform 24. When the loading plate 10 arrives at the second gate 23, the two mechanic arms release the middle conveyer 25.

The cleaning assembly 26 is slidably disposed on the base 20. The cleaning assembly 26 includes a main body 261 and a nozzle 263 protruding from the main body 261. The main body 261 is slidably disposed on the base 20. The nozzle 263 extends into the protective mask 21 along the radial direction of the rotary platform 24, and faces the center of the rotary platform 24. The nozzle 263 is used for spraying cleaning fluid or drying gas onto the workpiece 200. In particular, the nozzle 263 spays cleaning fluid to wash the workpiece 200 for a predetermined period during which the rotary platform 24 rotates, and then the nozzle 263 spays drying gas to dry the workpiece 200. When the rotary platform 24 rotates, the main body 261 slides toward or away from the center of the platform 24, and thus the cleaning fluid or the drying gas can cover a large area of the rotary platform 24.

The blowdown apparatus 27 is fixed on the base 20 and communicates with the working space. The blowdown apparatus 27 is used for blowing off the cleaning fluid and the drying gas.

The first conveyer 30 and the second conveyer 40 are fixed on the base 20 and are respectively disposed on two opposite sides of the protective mask 21. The first conveyer 30 is disposed opposite to the first through hole 213, and is used for transporting the workpiece 200 to the middle conveyer 25 passing through the first gate 22. The second conveyer 40 is disposed opposite to the second through hole 214, and is used for transporting the workpiece 200 from the middle conveyer 25 passing through the second gate 23.

The controller 50 is electrically connected to the first gate 22, the second gate 23, the rotary platform 24, the cleaning assembly 26, the middle conveyer 25, the first conveyer 30, and the second convey 40. In addition, is used for controlling the first gate 22, the second gate 23, the rotary platform 24, the cleaning assembly 26, the middle conveyer 25, the first conveyer 30, and the second convey 40 to work in turn.

In use, the workpiece 200 is loaded on the loading plate 10, the first conveyer 30 transports the loading plate 10 to the first gate 22, the first gate 22 is opened, the first conveyer 30 transports the loading plate 10 to the middle conveyer 25, then the first gate 22 is closed. When the loading plate 10 arrives at the center of the rotary platform 24, the two mechanic arms (not shown) firmly seize the middle conveyer 25. The rotary platform 24 starts to rotate, the main body 261 slides along the radial direction of the rotary platform 24, the nozzle 263 sprays cleaning fluid onto the workpiece 200 for a predetermined period to wash the workpiece 200, and then the nozzle 263 sprays drying gas to dry the workpiece 200. The blowdown apparatus 27 blows off the cleaning fluid and the drying gas. When the middle conveyer 25 is aligned with the second gate 23, the rotary platform 24 stops rotating. The middle conveyer 25 transports the loading plate 10 to the second gate 23, the second gate 23 is opened, the middle conveyer 25 transports the loading plate 10 to the second conveyer 40, and the second gate 23 is closed. The cleaning fluid can fly away from the workpiece 200 when the workpiece 200 rotates, and cannot remain on the workpiece 200, and thus not form blemishes on the workpiece 200. The drying gas will speed up the drying speed of the workpiece 200.

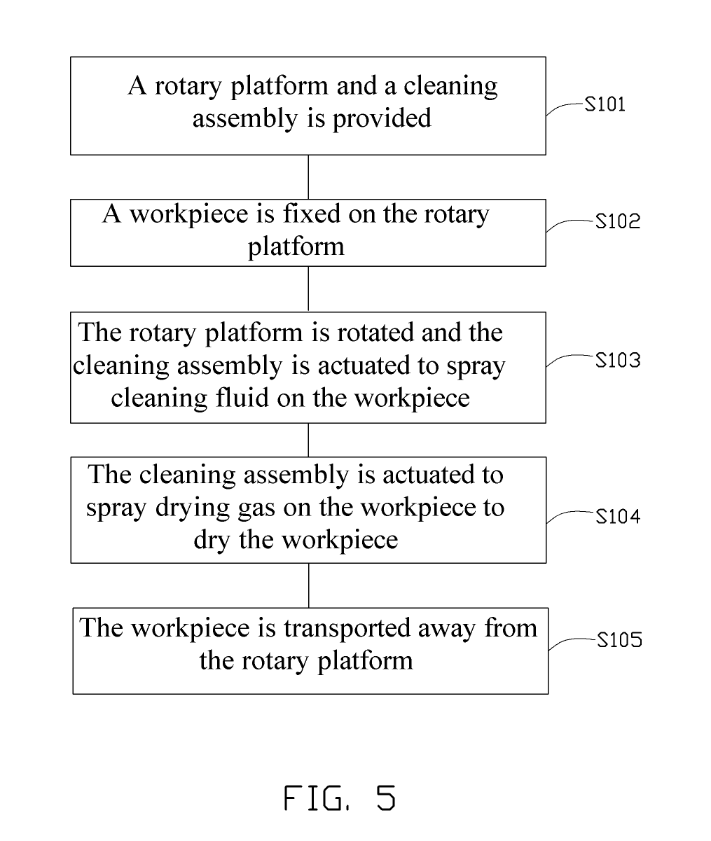

Referring to FIG. 5, an exemplary embodiment of a cleaning method using the cleaning device 100 includes the following steps.

In S101, a rotary platform and a cleaning assembly is provided. In this embodiment, the cleaning device 100 with the rotary platform 24 and the cleaning assembly 26 is provided.

In S102, a workpiece is fixed on the rotary platform. In this embodiment, the workpiece 200 is loaded on the loading plate 10, and the loading plate 10 is disposed on the first conveyer 30, the first gate 22 is opened, the first conveyer 30 transports the workpiece 200 to the middle conveyer 25. The first gate 22 is closed. Then the middle conveyer 25 transports the workpiece 200 to the center of the rotary platform 24.

In S103, the rotary platform is rotated and the cleaning assembly is actuated to spray cleaning fluid on the workpiece to wash the workpiece for a predetermined period. In this embodiment, the rotary platform 24 starts to rotate, the cleaning assembly 26 sprays cleaning fluid onto the workpiece 200 to wash the work piece 200 for a predetermined period, the blowdown apparatus 28 blows off the cleaning fluid. In particular, the cleaning assembly 26 slides forward or away from the center of the platform along the radial direction of the rotary platform 24 to spray the cleaning fluid on large area of the rotary platform 24.

In S104, the cleaning assembly is actuated to spray drying gas on the workpiece to dry the workpiece. In this embodiment, the cleaning assembly 26 slides forward or away from the center of the rotary platform 24 along the radial direction of the rotary platform 24 to spray the drying gas on large area of the rotary platform 24, and the blowdown apparatus 27 blows off the drying gas.

In S105, the workpiece is transported outward from the rotary platform. In this embodiment, the second gate 23 is opened, the middle conveyer 25 transports the work piece 200 to the second conveyer 40, then the work piece 200 can be packaged.

In other embodiments, the cleaning assembly 26 can also have two nozzles 263, one of the two nozzles 263 sprays cleaning fluid, the other one of the two nozzle 263 sprays drying gas.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A cleaning device, comprising:
a rotary platform configured for rotating a workpiece; and
a cleaning assembly facing the rotary platform and configured for spraying cleaning fluid on the workpiece for a predetermined period of time to clean the workpiece and then spraying drying gas on the workpiece to dry the workpiece when the rotary platform rotates the workpiece.

2. The cleaning device of claim 1, wherein the cleaning device further comprises a base, a protective mask, a first gate, and a second gate, the protective mask is positioned on the base, the base and the protective mask cooperatively define a working space, the rotary platform is rotatably positioned on the base, and is received in the working space, the protective mask comprises two opposite inner sidewalls, one of the two first inner sidewalls defines a first through hole, the other of the two first inner sidewalls defines a second through hole opposite to the first through hole, the first gate movably seals the first through hole, the second gate movably seals the second through hole.

3. The cleaning device of claim 2, wherein the cleaning device further comprises an first conveyer, an second conveyer, and a middle conveyer, the first conveyer and the second conveyer are positioned on two opposite sides of the protective mask, the middle conveyer is positioned on the rotary platform and extends from the first through hole to the second through hole, the first conveyer is configured for transporting the workpiece to the middle conveyer, the second conveyer is configured for taking over the workpiece from the middle conveyer.

4. The cleaning device of claim 3, wherein the middle conveyer is configured for transporting the workpiece to the center of the rotary platform to be washed by the cleaning assembly, and then transporting the workpiece to the second conveyer after the workpiece is washed.

5. The cleaning device of claim 4, wherein the cleaning device comprises a loading plate for loading the workpiece, the loading plate is capable of sliding from the first conveyer through the middle conveyer to the second conveyer.

6. The cleaning device of claim 5, wherein the protective mask further comprises a top wall perpendicularly connecting the two first inner sidewalls.

7. The cleaning device of claim 6, wherein the top wall defines an opening, the protective mask comprises a transparent cover sealing the opening.

8. The cleaning device of claim 2, wherein the cleaning assembly comprises a main body and a nozzle protruding from the main body, the main body is positioned on the base, and is capable of sliding toward or away the rotary platform, the nozzle extends into the protective mask and faces the rotary platform, the nozzle is configured for spraying the cleaning fluid for a predetermined period of time to wash the workpiece, and spraying the drying gas to dry the workpiece.

9. The cleaning device of claim 2, wherein the cleaning assembly comprises a main body, a first nozzle, and a second nozzle, the main body is positioned on the base, and is capable of sliding toward or away the rotary platform, both of the first nozzle and the second nozzle extend into the protective mask and face the rotary platform, the first nozzles is configured for spraying the cleaning fluid on the workpiece for a predetermined period of time to wash the workpiece, the second nozzles is configured for spraying the drying gas on the workpiece to dry the workpiece.

10. The cleaning device of claim 9, wherein the cleaning device further comprises a blowdown apparatus, the blowdown apparatus communicates with the working space, and is configured for blowing off the cleaning fluid and the drying gas.

11. The cleaning device of claim 10, wherein the cleaning device further comprises a controller, the controller is configured for controlling the rotary platform, the cleaning assembly, the blowdown apparatus, the middle conveyer, the first gate, the second gate, the first conveyer, and the second convey.

12. A cleaning method, comprising:
providing a rotary platform and a cleaning assembly;
positioning a workpiece on the rotary platform;
rotating the rotary platform;
actuating the cleaning assembly to spray cleaning fluid on the workpiece to wash the workpiece for a predetermined period of time; and
actuating the cleaning assembly to spray drying gas on the workpiece to dry the workpiece.
